(19) United States
(12) Patent Application Publication
(10) Pub. No.: US 2025/0242181 A1
(43) Pub. Date: Jul. 31, 2025

(54) ULTRA-THIN DIRECT FLAME BARRIER

(71) Applicant: MACRO-Lite, LLC, Lenexa, KS (US)

(72) Inventors: Damon Anderson, Shawnee, KS (US); Chase Ringwall, Kansas City, MO (US); Michael Breslin, Cooper City, FL (US)

(21) Appl. No.: 19/068,588

(22) Filed: Mar. 3, 2025

Related U.S. Application Data
(63) Continuation-in-part of application No. PCT/US2023/073289, filed on Sep. 1, 2023.
(60) Provisional application No. 63/403,394, filed on Sep. 2, 2022.

(51) Int. Cl. A62C 2/06; B32B 7/027; B32B 7/12; B32B 15/04; B32B 18/00

(52) U.S. Cl. CPC A62C 2/065; B32B 7/027; B32B 7/12; B32B 15/04; B32B 18/00; B32B 2250/05; B32B 2307/3065; B32B 2307/7376; B32B 2311/24; B32B 2311/30; B32B 2318/00

(57) ABSTRACT

Embodiments relate to a flame barrier that may be adhered or mechanically fastened to a substrate to provide fire resistance and/or an outer protective surface. The flame barrier may alternatively be adhered or mechanically fastened to an existing flame barrier to provide increased fire resistance and/or increased protective ability. The flame barrier is configured to protect against high temperature flames, prevent flame penetration, and contain aggressive flames to reduce the severity of the flame's impact, heat, and velocity.

### CROSS-REFERENCE TO RELATED APPLICATIONS

This application is a continuation-in-part of and claims priority to International Application PCT/US2023/073289, filed on Sep. 1, 2023. The entirety of International Application PCT/US2023/073289 is incorporated by reference herein. International Application PCT/US2023/073289 is related to and claims the benefit of U.S. Provisional Application No. 63/403,394, filed on Sep. 2, 2022. The entirety of U.S. Provisional Application No. 63/403,394 is incorporated by reference herein.

### FIELD OF THE INVENTION

Embodiments relate to a flame barrier, particularly to an ultra-thin, lightweight flame barrier and methods of making and using thereof.

### BACKGROUND OF THE INVENTION

The present disclosure relates to an ultra-thin, lightweight flame barrier that displays improved performance over existing flame barriers.

Currently, lightweight flame barriers, as used in aircraft or vehicles, are typically designed as layers that are attached to an existing structure and optimized for weight, insulation, and direct temperature capabilities. Current flame barriers typically insulate the existing structure against degradation from flame exposure through the use of non-woven or thin veil fibers, which have a melting temperature above that of the flame they are designed to withstand. Additionally, flame barriers may have a film or foil that acts as a carrier, protective outer surface, and/or radiant barrier on one or both sides of an insulation material. However, current flame barriers remain susceptible to degradation from the combination of high temperature flames (e.g., over 2000° F.), direct flame impingement, and high air/fuel velocity.

Current flame barriers are also noticeably deficient against aggressive, high temperature flames, molten electrolyte expulsion, hydrofluoric acid exposure, and/or burning metal particles detached from a failed battery, such as in battery thermal runaway events. Generally, the market is full of flame and fire protection barriers configured for use against flames of 1,500-2,000° F. However, fires become more complex and energetic at higher temperatures (e.g., lithium battery fires), and current solutions become exotic, complex, and expensive.

There are no lightweight, cost-effective systems capable of augmenting the multitude of existing fire-resistant products against higher temperature, aggressive flames and/or adding protection against molten electrolyte expulsion, hydrofluoric acid exposure, and/or burning metal particles present in high temperature fires. Accordingly, there is a need for a lightweight flame barrier that protects against high temperature flames, prevents flame penetration, and contains aggressive flames to reduce the severity of the flame's impact, heat, and velocity on a substrate.

### SUMMARY OF THE INVENTION

Embodiments relate to a flame barrier that may be adhered or mechanically fastened to a substrate to provide fire resistance and optionally, an outer protective surface. The flame barrier may alternatively be adhered to an existing flame barrier to provide increased fire resistance and increased protective ability against more energetic, higher temperature flame events.

In an exemplary embodiment, a flame barrier comprises a first metallic layer having a thickness of from 0.08 mils or greater to 20 mils or less; a second metallic layer having a thickness of from 0.08 mils or greater to 20 mils or less; and a non-metallic layer positioned between the first metallic layer and the second metallic layer, wherein the flame barrier is configured to maintain a cold side temperature of 700° F. or less in an environment with temperatures up to 2,400° F.

In some embodiments, the first metallic layer has a thickness of from 0.8 mils or greater to 2 mils or less, and wherein the second metallic layer has a thickness of from 0.8 mils or greater to 2 mils or less.

In some embodiments, the first metallic layer is a first metal foil layer comprising a first metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

In some embodiments, the second metallic layer is a second metal foil layer comprising a second metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

In some embodiments, the first metal is the same as the second metal.

In some embodiments, the first metal is different than the second metal.

In some embodiments, the non-metallic layer comprises a material selected from the group consisting of woven silica fabric, woven vermiculite coated fiberglass, non-woven silica fiber, woven aramids, mica, ceramic, basalt, para-aramid, meta-aramid, carbon, graphite, glass fiber, and mixtures thereof.

In some embodiments, the non-metallic layer comprises ceramic.

In some embodiments, the non-metallic layer is attached to the first metallic layer and the second metallic layer via an adhesive.

In some embodiments, the adhesive comprises at least one inorganic salt and an aqueous binder solution.

In some embodiments, the at least one inorganic salt is sodium silicate.

In some embodiments, the flame barrier further comprises an air gap positioned between the first metallic layer and the non-metallic layer and/or between the second metallic layer and the non-metallic layer.

In some embodiments, the flame barrier further comprises a third metallic layer having a thickness of from 0.08 mils or greater to 20 mils or less; a second non-metallic layer positioned between the second metallic layer and the third metallic layer, wherein the flame barrier is configured to maintain a cold side temperature of 400° F. or less in an environment with temperatures up to 2,400° F.

In some embodiments, the third metallic layer has a thickness of from 0.8 mils or greater to 2 mils or less.

In some embodiments, the third metallic layer is a third metal foil layer comprising a third metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

In some embodiments, the third metal is the same as the first metal and/or the second metal.

In some embodiments, the third metal is different than the first metal and/or the second metal.

In some embodiments, the second non-metallic layer comprises a material selected from the group consisting of woven silica fabric, woven vermiculite coated fiberglass, non-woven silica fiber, woven aramids, mica, ceramic, basalt, para-aramid, meta-aramid, carbon, graphite, glass fiber, and mixtures thereof.

In some embodiments, the second non-metallic layer comprises ceramic.

In some embodiments, the non-metallic layer is attached to the first metallic layer and the second metallic layer via an adhesive, and wherein the second non-metallic layer is attached to the second metallic layer and the third metallic layer via the adhesive.

In some embodiments, the adhesive comprises at least one inorganic salt and an aqueous binder solution.

In some embodiments, the at least one inorganic salt is sodium silicate.

In some embodiments, the flame barrier further comprises an air gap positioned between the first metallic layer and the non-metallic layer and/or between the second metallic layer and the non-metallic layer and/or between the second metallic layer and the second non-metallic layer and/or between the third metallic layer and the second non-metallic layer.

In some embodiments, the flame barrier further comprises a fourth metallic layer, a fifth metallic layer, a sixth metallic layer, and a seventh metallic layer, each having thicknesses of from 0.08 mils or greater to 20 mils or less; a third non-metallic layer positioned between the third and fourth metallic layers, a fourth non-metallic layer positioned between the fourth and fifth metallic layers, a fifth non-metallic layer positioned between the fifth and sixth metallic layers, and a sixth non-metallic layer positioned between the sixth and seventh metallic layers, wherein the flame barrier is configured to maintain a cold side temperature of 250° F. or less in an environment with temperatures up to 2,400° F.

In some embodiments, the fourth, fifth, sixth, and seventh metallic layers each have a thickness of from 0.8 mils or greater to 2 mils or less.

In some embodiments, the fourth, fifth, sixth, and seventh metallic layers are each a metal foil layer comprising a metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

In some embodiments, the third, fourth, fifth, and sixth non-metallic layers each comprise a material selected from the group consisting of woven silica fabric, woven vermiculite coated fiberglass, non-woven silica fiber, woven aramids, mica, ceramic, basalt, para-aramid, meta-aramid, carbon, graphite, glass fiber, and mixtures thereof.

In some embodiments, the third, fourth, fifth, and sixth non-metallic layers each comprise ceramic.

In some embodiments, all layers are attached via an adhesive,

In some embodiments, the adhesive comprises at least one inorganic salt and an aqueous binder solution.

In some embodiments, the at least one inorganic salt is sodium silicate.

In some embodiments, an air gap is positioned between one, some, or all of the layers.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIGS. 1A-1C are schematic illustrations showing exploded cross-sectional views of exemplary embodiments of a flame barrier.

FIGS. 2A-2H are schematic illustrations showing exploded cross-section views of exemplary flame barriers with various arrangements and sequences of one or more metallic layer(s) and one or more non-metallic layer(s).

FIGS. 3A-3C are schematic illustrations showing exploded cross-section views of exemplary flame barriers with various arrangements of metallic portions with one or more metallic layer(s) and non-metallic portions with one or more non-metallic layer(s).

FIGS. 4A-4B are schematic illustrations showing exploded cross-section views of exemplary flame barriers including at least one insulating layer.

FIGS. 5A-5B are schematic illustrations showing exploded cross-section views of exemplary flame barriers including at least one laminate layer.

FIGS. 6A-6D are schematic illustrations showing exploded cross-section views of exemplary flame barriers including at least one metal foil layer.

FIG. 7 is a schematic illustration showing an exploded cross-section view of an exemplary flame barrier including a deposited metallic layer.

FIG. 8 is a schematic illustration showing an exploded cross-section view of an exemplary flame barrier including an armor layer.

FIG. 9 is a schematic illustration showing an exploded cross-section view of an exemplary flame barrier including an air gap.

FIG. 10 is a schematic illustration showing an exploded cross-section view of an exemplary flame barrier including a paper facing.

FIGS. 11-13 are schematic illustrations showing exemplary uses of exemplary flame barriers.

FIG. 14 is an exemplary testing setup used to measure cold side temperatures of tested flame barriers.

FIG. 15 is a graph demonstrating the measured cold side temperatures of tested flame barriers over a period of time.

FIG. 16A is an exemplary testing setup used to measure cold side temperatures of tested flame barriers, and particularly shows 8-inch by 8-inch samples affixed in place using clamp loading on the sides of the samples.

FIG. 16B is an exemplary testing setup used to measure cold side temperatures of tested flame barriers, and particularly shows two K-type thermocouples placed on the cold face of a sample, in line with a torch head.

FIGS. 17A and 17B is an exemplary testing setup used to measure cold side temperatures of tested flame barriers and particularly shows a B-type thermocouple placed 2.5″ from the tip of the torch and utilized to calibrate the flame temperature.

FIG. 17C displays a recorded temperature used to calibrate the flame temperature.

FIG. 18 is an exemplary testing setup used to measure cold side temperatures of tested flame barriers and particularly shows that once a desired temperature was reached, a torch was brought 2.5″ from the surface of a sample and held in place for the duration of a test.

FIGS. 19-28 are graphs demonstrating the measured cold side temperatures of tested flame barriers over a period of time.

### DETAILED DESCRIPTION OF THE INVENTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

All references to singular characteristics or limitations of the present disclosure shall include the corresponding plural characteristic(s) or limitation(s) and vice versa, unless otherwise specified or clearly implied to the contrary by the context in which the reference is made.

As used herein (when used in this application, including the claims), the terms “a,” “an,” and “the” refer to “one or more.” The use of the word “a” or “an” when used in conjunction with the term “comprising” in the claims and/or the specification may mean “one,” but it is also consistent with the meaning of “one or more,” “at least one,” and “one or more than one.”

It is understood that disclosure of a range discloses each value included within that range.

The apparatuses and systems of the present disclosure, including components thereof, can comprise, consist of, or consist essentially of the components and limitations of the embodiments described herein, as well as any additional or optional components or limitations described herein or otherwise useful.

Embodiments generally relate to apparatuses and systems configured to provide protection against high temperature flames, prevent flame penetration, and contain aggressive flames. An exemplary apparatus may be a flame barrier including one or more layers (e.g., one or more metallic layers and one or more non-metallic layers) attached to one another. As used herein, the term “flame barrier” may refer to any fire-resistance barrier designed to protect structural elements and/or prevent the spread of fire.

It is understood that a flame barrier includes a hot face and an opposite cold face. As used herein, the term “hot face” refers to a side or surface of the flame barrier that is exposed to heat or flames, and the term “cold face” refers to a side or surface of the flame barrier that faces away from a heat or flame source. Accordingly, as used herein, the term “cold side temperature” refers to a measurable temperature of the cold face of the flame barrier.

In exemplary embodiments, a flame barrier is configured to protect a substrate from high temperatures such that the time in which the substrate may withstand flame impingement and high temperatures is increased. The flame barrier may protect a substrate from flames with flame temperatures up to 2,000° F., up to 2,050° F., up to 2,100° F., up to 2,150° F., up to 2,200° F., up to 2,250° F., up to 2,300° F., up to 2,350° F., up to 2,400° F., up to 2,450° F., up to 2,500° F., up to 2,550° F., up to 2,600° F., up to 2,700° F., up to 2,750° F., up to 3,000° F., up to 3,250° F., up to 3,500° F., up to 3,750° F., up to 4,000° F., up to 4,250° F., and in some embodiments, up to 4,500° F.

The flame barrier is further configured to maintain a cold side temperature of no greater than 800° F., no greater than 750° F., no greater than 700° F., no greater than 650° F., no greater than 600° F., no greater than 550° F., no greater than 500° F., no greater than 450° F., no greater than 400° F., no greater than 350° F., no greater than 300° F., and in some embodiments, no greater than 250° F., in environments with the previously described flame temperatures. The flame barrier may be configured to maintain the cold side temperature for a time period up to 30 seconds, up to 1 minute, up to 90 seconds, up to 2 minutes, up to 150 seconds, up to 3 minutes, up to 210 seconds, up to 4 minutes, up to 240 seconds, up to 5 minutes, up to 10 minutes, up to 15 minutes, up to 30 minutes, up to 60 minutes, up to 120 minutes, up to 1 day, and in some embodiments, for an indefinite period of time.

The cold side temperature to be maintained, and the time for which the cold-side temperature is maintained, may be tailored based on any one or combination of a number of factors, such as the number of layers included in the flame barrier, the layers (number of layer, arrangement of layers, and/or materials used) of the flame barrier, the thicknesses of layers, etc.

The flame barrier may be lightweight to minimize any potential adverse impact on a substrate. The weight of the flame barrier may be modified and optimized depending on a particular use. The flame barrier may have a weight of 0.03 to 0.5 lbs/ft². Generally, the flame barrier preferably has a weight of 0.03 to 0.2 lbs/ft².

It is surprising that the flame barrier may have such a low weight and limited thickness while still maintaining a high temperature protection, more specifically while still maintaining cold side temperatures in environments with the flame temperatures previously described.

In some embodiments, the flame barrier may be flexible, such that the flame barrier may complement the shape, contour, and/or topology of any substrate.

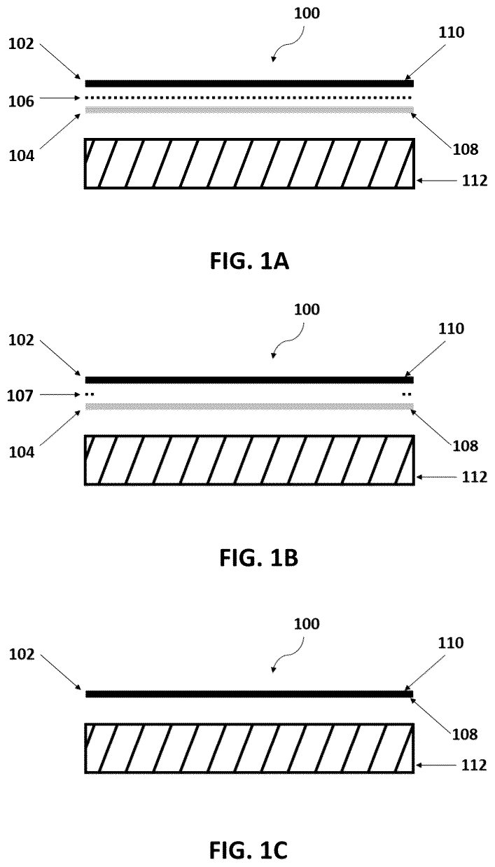

In one exemplary embodiment shown in FIGS. 1A and 1B, a flame barrier 100 has a plurality of layers, including a primary (e.g., metallic) layer 102 and a secondary (e.g., non-metallic) layer 104. The metallic layer 102 and the non-metallic layer 104 are attached to one another, such as via an adhesive 106 or a mechanical fastener 107. The flame barrier 100 may have a cold face 108 and a hot face 110. Either the metallic layer or the non-metallic layer may be the cold face 108, and either a metallic layer or a non-metallic layer may be the hot face 110.

In some embodiments, the layers are selected based on insulative properties (e.g., R-values) or conductive properties (e.g., U-values), depending on the function of a particular layer in the overall flame barrier 100.

In an alternative embodiment shown in FIG. 1C, a flame barrier 100 has a metallic layer 102, wherein the metallic layer 102 comprises both the cold face 108 and the hot face 110.

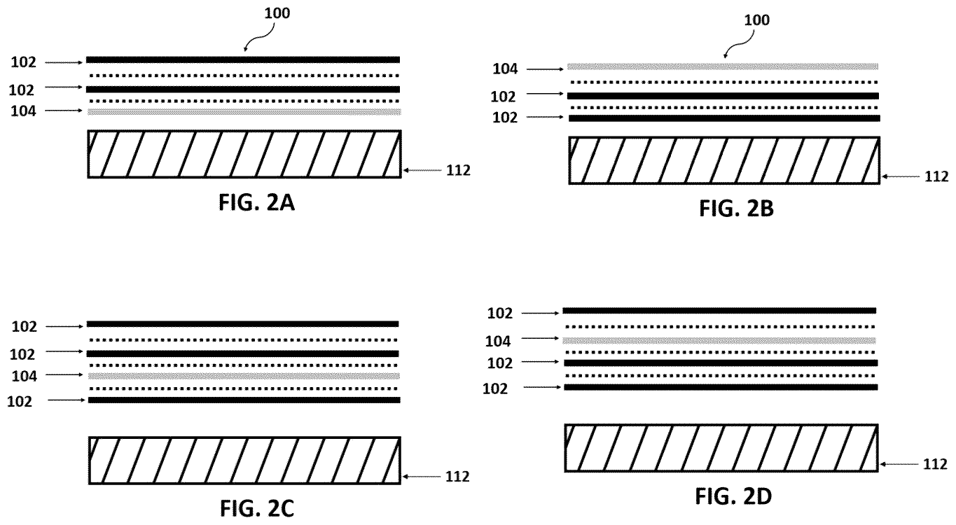

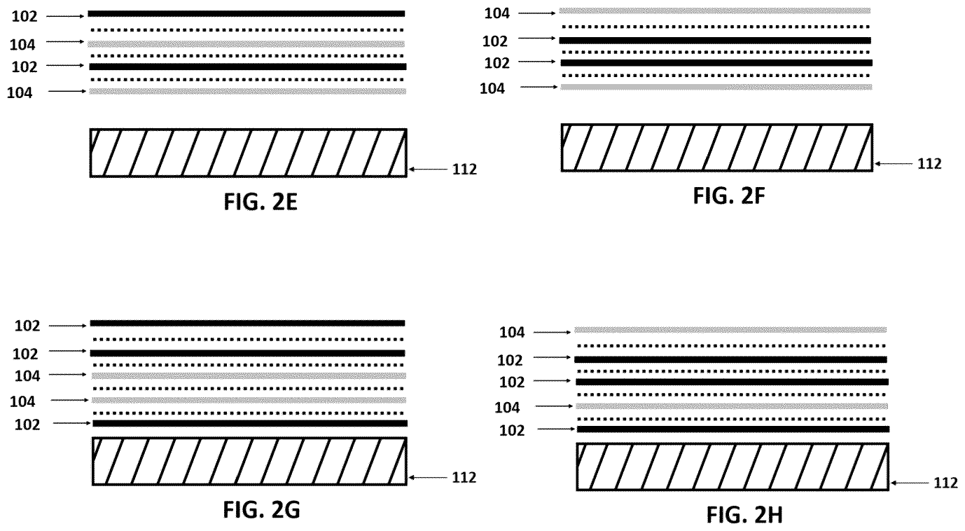

In other embodiments, a flame barrier 100 may include at least one metallic layer 102 and at least one non-metallic layer 104. A flame barrier 100 may include any possible arrangement or sequence of metallic layer(s) 102 and non-metallic layer(s) 104. For example, while a metallic layer 102 and a non-metallic layer 104 may be attached to one another as previously described, one metallic layer may similarly be attached to another metallic layer, such as via an adhesive 106 or a mechanical fastener 107, and one non-metallic layer may be attached to another non-metallic layer, such as via an adhesive 106 or a mechanical fastener 107. While FIGS. 2A-2H demonstrate various possible arrangements and sequences of metallic layer(s) 102 and non-metallic layer(s) 104, these figures are only exemplary, and all other possible arrangements and sequences are contemplated as being included within the scope of this disclosure.

A flame barrier 100 may include an alternating arrangement of one or more metallic portions and one or more non-metallic portions. As used herein, a “metallic portion” may refer to one or more consecutive metallic layer(s) 102 (e.g., one consecutive metallic layer, two consecutive metallic layers, three consecutive metallic layers, four consecutive metallic layers, five consecutive metallic layers, etc.), and a “non-metallic portion” may refer to one more consecutive non-metallic layer(s) 104 (e.g., one consecutive non-metallic layer, two consecutive non-metallic layers, three consecutive non-metallic layers, four consecutive non-metallic layers, five consecutive non-metallic layers, etc.).

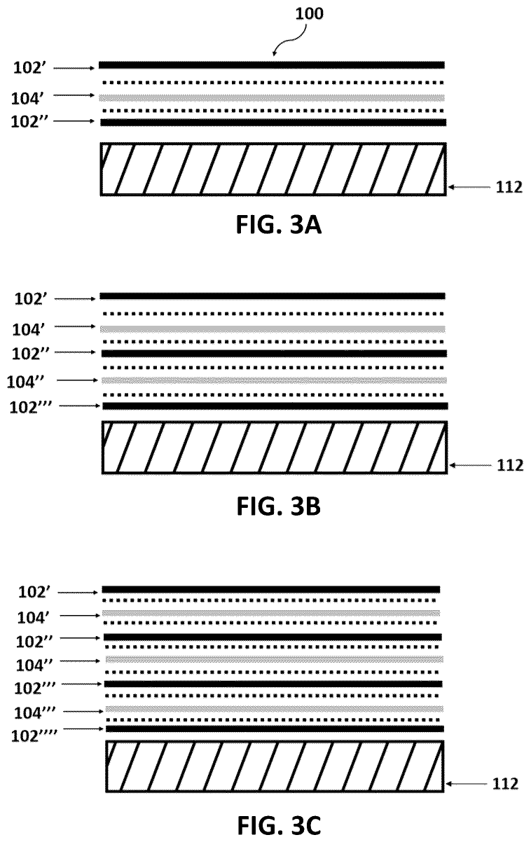

For example, as seen in FIG. 3A, a flame barrier 100 may include a first metallic portion 102′ and a second metallic portion 102″, with a non-metallic portion 104′ positioned therebetween. Referring to FIG. 3B, a flame barrier 100 may include a first metallic portion 102′, a second metallic portion 102″, a first non-metallic portion 104′ positioned between the first and second metallic portions, a third metallic portion 102′″, and a second non-metallic portion 104″ positioned between the second and third metallic portions. Referring to FIG. 3C, a flame barrier 100 may include a first metallic portion 102′, a second metallic portion 102″, a first non-metallic portion 104′ positioned between the first and second metallic portions, a third metallic portion 102′″, a second non-metallic portion 104″ positioned between the second and third metallic portions, a fourth metallic portion 102″″, and a third non-metallic portion 104′″ positioned between the third and fourth metallic portions. While FIGS. 3A-3C demonstrate various possible alternating arrangements of metallic portions and non-metallic portions, these figures are only exemplary, and all other possible alternating arrangements are contemplated as being included within the scope of this disclosure. Further, while the above arrangements are described with a metallic layer being the cold face 108, a non-metallic layer may be the cold face 108. Similarly, while the above arrangements are described with a metallic layer being the hot face 110, a non-metallic layer may be the hot face 110.

A non-metallic layer 104 may have a thickness of from 0.08 mils or greater to 125 mils or less, more preferably from 1 mil or greater to 20 mils or less. In some embodiments, the non-metallic layer is 1 mil, 2 mils, 3 mils, 4 mils, 5 mils, 6 mils, 7 mils, 8 mils, 9 mils, 10 mils, 11 mils, 12 mils, 13, mils, 14 mils, 15 mils, 16 mils, 17 mils, 18 mils, 19 mils, 20 mils, etc. In alternative embodiments, the flame barrier 100 may not comprise a non-metallic layer 104 (e.g., the metallic layer 102 is used alone).

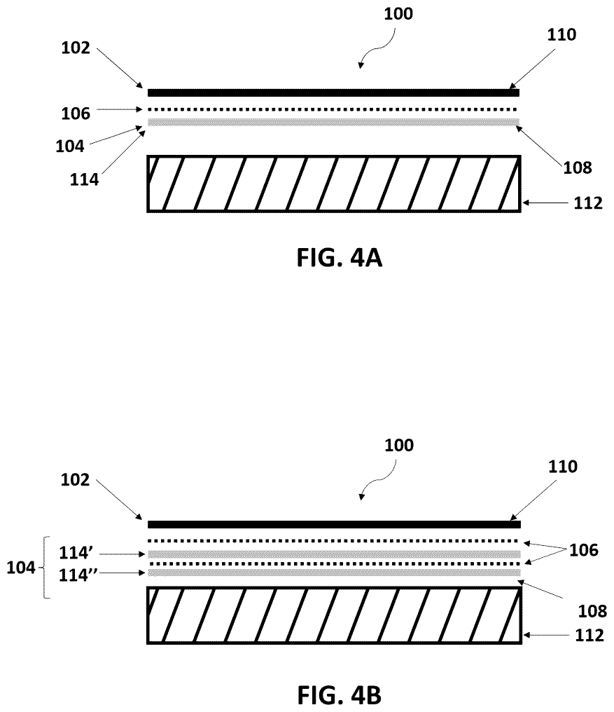

A non-metallic layer 104 may be an insulating layer 114 (see FIG. 4A). In some embodiments, an insulating layer 114 is not inherently flammable or combustible. In some embodiments, an insulating layer is inorganic. An insulating layer 114 may be a material such as, but not limited to, woven silica fabric, woven vermiculite coated fiberglass, non-woven silica fiber, woven aramids, mica, ceramic, basalt, para-aramid, meta-aramid, carbon, graphite, glass fiber, or any other suitable material and mixtures thereof. In some embodiments, an insulating layer 114 may be the cold face 108 and be configured to attach to a substrate 112. In other embodiments, an insulating layer 114 may be the hot face 110.

In some embodiments, an insulating layer 114 can be a deposited ceramic layer. For example, a ceramic may be deposited vie known deposition techniques, such as physical vapor deposition (e.g., sputtering) or chemical vapor deposition. The deposited ceramic may be a ceramic such as, but not limited to, alumina/aluminum oxide (Al₂O₃), magnesium oxide (MgO), beryllium oxide (BeO), zirconium oxide (ZrO₂), antimony Oxide (Sb₂O₃), barium titanate (BaTiO₃), Barium zirconate (BaZrO₃), or any other suitable ceramic and mixtures thereof.

Referring to FIG. 4B, a flame barrier 100 may comprise a plurality of insulating layers 114 as described above. In some embodiments, a plurality of insulating layers 114 may be configured as consecutive layers. An adhesive 106 or mechanical fastener 107 may attach the plurality of insulating layers 114 to one another. In other embodiments, a plurality of insulating layers 114 may be configured as non-consecutive layers. As used herein, an insulating layer 114 generally describes layers 114′ and/or 114″. A plurality of insulating layers 114 may comprise the same or different material than other insulating layers, for example an insulating layer 114′ may comprise the same material as or a different material than an insulating layer 114″. Further, the insulating layer 114′ may comprise the same thickness as or a different thickness than the insulating layer 114″.

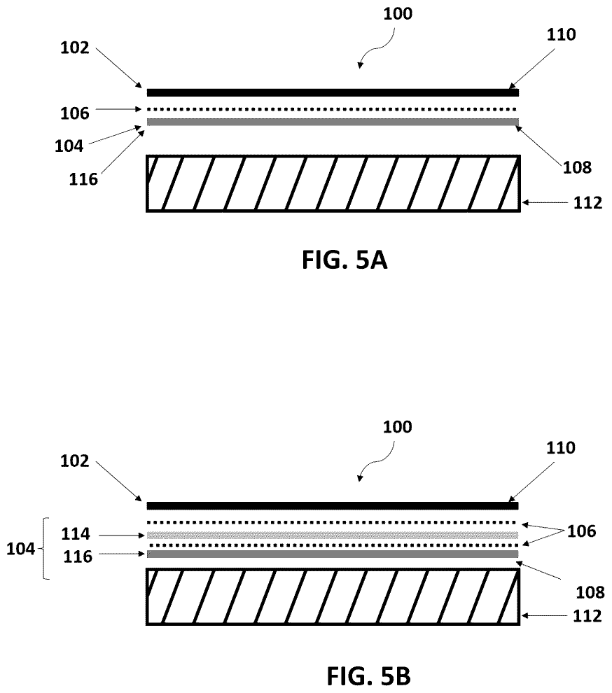

A non-metallic layer 104 may be a laminate layer 116 (see FIGS. 5A and 5B). In some embodiments, a laminate layer 116 may not be inherently flammable or combustible. A laminate layer 116 may be a material such as, but not limited to, ceramic, basalt, para-aramid, meta-aramid, carbon, graphite, glass fiber, or any other suitable material, papers thereof, chops thereof, pulps thereof, or mixtures thereof. In some embodiments, a laminate layer 116 may be the cold face 108 and be configured to attach to a substrate 112. In other embodiments, a laminate layer 116 may be the hot face 110.

In embodiments including a plurality of non-metallic layers 104, a non-metallic layer may be different than or the same as other non-metallic layers. For example, referring to FIG. 2F, a first non-metallic layer may be an insulating layer, and a second non-metallic layer may be a second insulating layer, a laminate layer, etc.

A metallic layer 102 may be selected to protect against high temperature flames and prevent flame penetration. A metallic layer 102 may further be selected to protect against impact.

A metallic layer 102 may be a metal foil layer 118, a deposited metallic layer 120, or an armor layer 122.

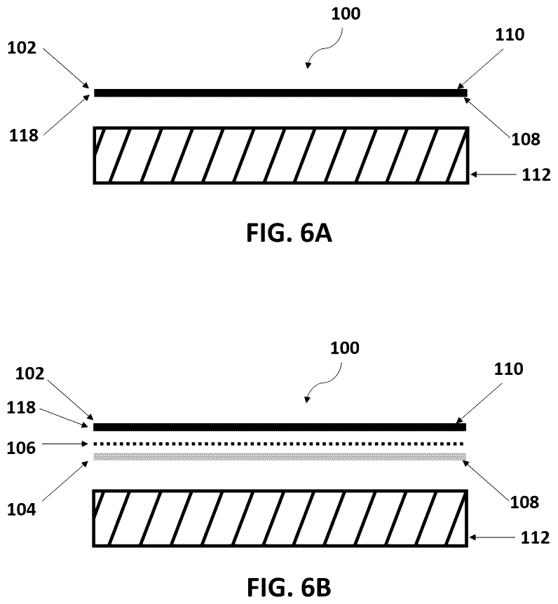

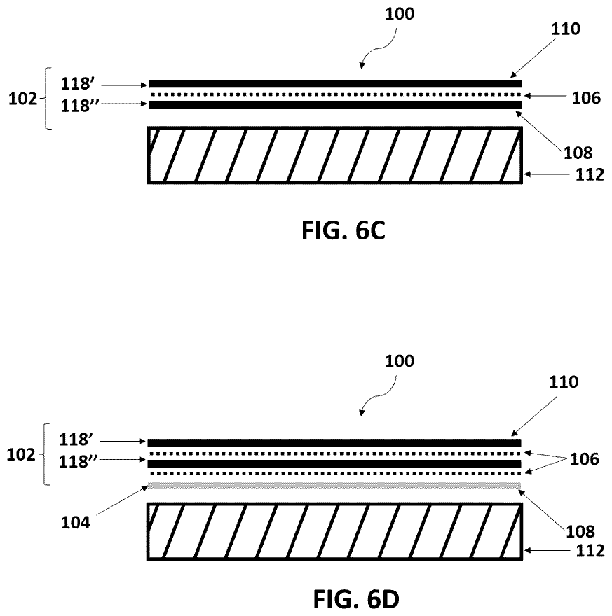

Referring to FIGS. 6A and 6B, a metallic layer 102 may be a metal foil layer 118. A metal foil layer 118 may be a foil such as, but not limited to, alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), or any other suitable foil and mixtures thereof.

A metal foil layer 118 may have a thickness of from 0.08 mils or greater to 20 mils or less, more preferably from 0.8 mils or greater to 2 mils or less. In some embodiments, the non-metallic layer is 0.08 mils, 0.8 mils, 1 mil, 2 mils, 3 mils, 4 mils, 5 mils, 6 mils, 7 mils, 8 mils, 9 mils, 10 mils, 11 mils, 12 mils, 13, mils, 14 mils, 15 mils, 16 mils, 17 mils, 18 mils, 19 mils, 20 mils, etc. A metal foil layer 118 may be the hot face 110 and be configured to be exposed (e.g., to a flame). A metal foil layer 118 may have a high thermal conductivity and/or high thermal mass, such that the metallic layer 102 may continuously resist flame penetration and move heat away from the flame zone to spread heat over a larger area. This is advantageous as it reduces both the severity of the flame impact on subsequent layers and increases the time in which the flame barrier 100 can withstand flame impingement.

In some embodiments, as shown in FIGS. 6C and 6D, a flame barrier 100 may comprise a plurality of metal foil layers 118 as described above. In some embodiments, the plurality of metal foil layers 118 may be configured as consecutive layers. An adhesive 106 or mechanical fastener 107 may attach the plurality of metal foil layers to one another. In other embodiments, a plurality of metal foil layers 118 may be configured as non-consecutive layers. As used herein, metal foil layer 118 generally describes layers 118′ and/or 118″. A plurality of metal foil layers 118 may comprise the same or different foil than other metal foil layers, for example a metal foil layer 118′ may comprise the same foil as or a different foil than a metal foil layer 118″. For example, a first metal foil layer may be stainless steel and a second metal foil layer may be aluminum, copper, etc. Further, a metal foil layer 118′ may comprise the same thickness as or a different thickness than a metal foil layer 118″.

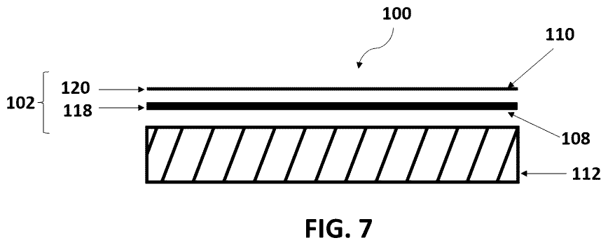

In some embodiments, as shown in FIG. 7, a metallic layer 102 may be a deposited metallic layer 120. For example, a metal may be deposited via known deposition techniques, such as physical vapor deposition (e.g., sputtering) or chemical vapor deposition. The deposited metal may be a metal such as, but not limited to, alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), or any other suitable metal and mixtures thereof. A deposited metallic layer 120 may be the hot face 110. Further, a metallic layer 120 may be deposited on a metal foil layer 118, on a non-metallic layer 104, or on any other suitable layer.

A thickness of a deposited metallic layer 120 is not particularly limited. In some embodiments, a deposited metallic layer 120 may have a thickness of from 0.00004 mils or greater to 0.2 mils or less, more preferably from 0.004 mils or greater to 0.08 mils or less.

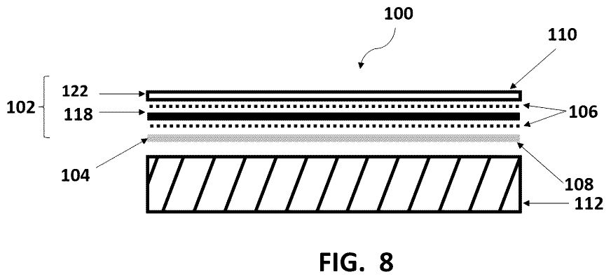

Referring to FIG. 8, a metallic layer 102 may be an armor layer 122. As used herein, an “armor” may refer to a material or material system designed to defeat kinetic energy projectiles. An armor layer 122 may be configured to absorb energy and damage. An adhesive 106 or mechanical fastener 107 may attach an armor layer 122 to other layers. In some embodiments, an armor layer 122 may be the hot face 110 of the flame barrier 100, or an armor layer 122 may be the cold face 108 of the flame barrier 100.

In embodiments including a plurality of metallic layers 102, a metallic layer may be different than or the same as other metallic layers. For example, referring to FIG. 2A, a first metallic layer may be a metal foil layer, and a second metallic layer may be a second metal foil layer, a deposited metallic layer, etc.

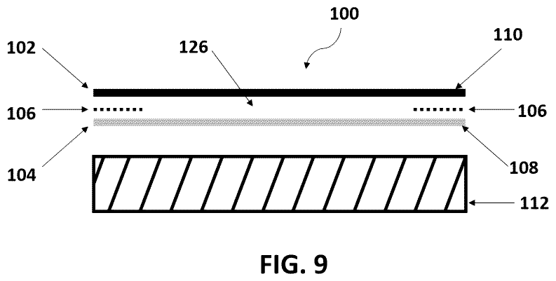

In some embodiments, as shown in FIG. 9, there may be an air gap 126 positioned between two consecutive layers, such as between a metallic layer and a non-metallic layer, between a first metallic layer and a second metallic layer, or between a first non-metallic layer and a second non-metallic layer. An air gap is understood to mean a discontinuity (e.g., empty space) between two layers. For example, adhesive 106 may attach a first layer and a second layer at discrete points, and an air gap 126 may form between said points. Alternatively, a mechanical fastener 107 may attach a first layer and a second layer at discrete points, and an air gap 126 may form between said points.

In embodiments including a plurality of layers, the layers may form a pillowing effect wherein the layers separate under flame impingement. This pillowing effect advantageously introduces an air gap 126 that interrupts conductive heat transfer through the flame barrier 100.

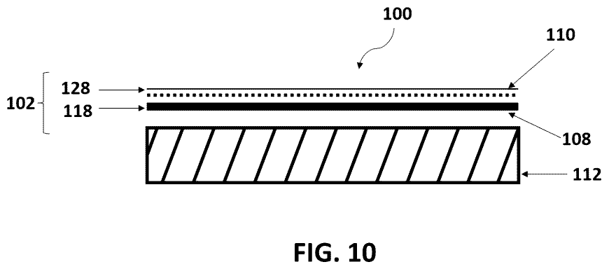

In exemplary embodiments shown in FIG. 10, the flame barrier 100 may comprise a paper facing 128, such as a ceramic paper facing. An adhesive 106 or mechanical fastener 107 may attach the paper facing 128 to a subsequent layer. A paper facing 128 may comprise the hot face 110 of the flame barrier 100. The paper facing 128 may have a thickness of 0.002 inches or less (i.e., not greater than 0.002 inches).

A paper facing 128 may add electrical insulation and durability to the flame barrier 100. Further, a paper facing may be lightweight and enable adhesive compatibility. The paper facing 128 may be doped with a polyurethane resin or a polyimide resin filled with titanium and/or tantalum powder.

As described above, an adhesive 106 may be used to attach layers to one another. The adhesive 106 may be a continuous layer, a discrete point, or a series of discrete points.

The adhesive 106 may be an intumescent compound, a low-flame/inflammable organic compound, an incombustible inorganic compound, or mixtures thereof. In some embodiments, the adhesive 106 preferably includes an incombustible inorganic compound. In some embodiments, the adhesive 106 may comprise at least one inorganic fusible salt dissolved in an aqueous binder solution. The inorganic fusible salt may be a salt such as, but not limited to, hydrated boron-containing compounds, hydrated sulfate compounds, various hydrated phosphate salts, and hydrated silicates and mixtures thereof. In a preferred embodiment, the salt is sodium silicate (Na₂SiO₃, also known as water glass).

Without wishing to be bound by theory, it is contemplated that the at least one fusible salt contains at least one water molecule bound to an inorganic salt and releases water through dehydration or decomposition when heated. The adhesive 106 creates a barrier to heat transfer and undergoes a chemical reaction upon heating that forms water, which cools, and suppresses a fire. During this chemical reaction, heat is absorbed and water vapor is released, thereby providing a cooling effect. Accordingly, the adhesive 106 may act as an incombustible adhesive rather than a flame-retardant adhesive.

When more than one salt is used, the additional salt (or salts) may have a higher water release threshold temperature. Continuous release of water molecules from the adhesive over a range of temperatures is desirable.

While not necessary for the success of the flame barrier 100, the adhesive 106 may penetrate or partially penetrate the layer to which it is applied, thereby impregnating the layer.

While sodium silicate may be employed as the salt to act as a combination adhesive and fire and/or heat barrier, compatible inorganic materials may be added to the sodium silicate to further enhance handling characteristics of the sodium silicate, and/or mechanical properties and/or fire and heat resistance of the resulting flame barrier. The additives should be soluble in, miscible with, or suspended in the sodium silicate solution, and should be non-reactive with sodium silicate, or, if reactive with the sodium silicate, the resulting reaction product(s) should be intumescent. For example, the additive may be fumed silica, as the addition of fumed silica to the sodium silicate increases the crystallization temperature of the sodium silicate and the fire resistance (combustion temperature) of a flame barrier produced therefrom.

Other inorganic salts and oxides (such as ferric oxide, titanium oxide, aluminum trihydrate, sodium aluminum sulfo-silicate, antimony trioxide and antimony pentoxide, mica, etc.), carbon-based materials (such as carbon black or graphite), and mixtures of one or more of the foregoing, which are given as exemplary additives, satisfy some or all of the aforesaid criteria and are useful in accordance with the flame barrier.

The adhesive 106 may further comprise other components such as, but not limited to, intumescing materials, expandable graphite, metallic powders (e.g., copper, titanium, tantalum, and/or iron), polyurethane, polyimide, acrylic, acrylate, silicone, thermoplastic films, thermoplastic scrim/webs, or any other suitable component and mixtures thereof.

The adhesive 106 may provide resistance to hydrofluoric acid. It is not uncommon for certain lithium-ion batteries to emit hydrofluoric acid (e.g., in liquid, vapor, or gaseous form) when the battery undergoes a catastrophic thermal event. Sodium silicate may provide such benefits, as sodium silicate is strongly basic and may react with and neutralize emitted hydrofluoric acid.

As described above, the flame barrier 100 may be used as a single layer structure, such that a metallic layer 102 is attached to a substrate 112, or the flame barrier 100 may be used as a multi-layer structure, such as one or more metallic layer(s) 102 and/or one or more non-metallic layer(s) 104, and the layers are attached to a substrate 112. In alternative embodiments, the flame barrier 100 may be used as a single layer structure such that a metallic layer 102 is mechanically fastened to the substrate 112, or the flame barrier 100 may be used as a multi-layer structure, such as one or more metallic layer(s) 102 and/or one or more non-metallic layer(s) 104, and the layers are mechanically fastened to the substrate 112. Mechanical fasteners include, but are not limited to, bolts, screws, rivets, or any other suitable mechanical fastener. The mechanical fastener may comprise a material such as, but not limited to, steel, titanium, etc.

Selection of layers of the flame barrier 100, materials of the respective layers, and order of the respective layers, may be a function of one or more factors such as the flame temperature, desired cold side temperature, secondary environmental stressors (e.g., solid/liquid impingement, handling strength, chemical exposure, etc.), and/or barrier geometry.

Traditional monolithic barrier materials can act as either insulators (e.g., fiberglass) or thermal conductors/heat sinks (e.g., metallic sheets). By combining insulative, non-metallic layers (high R-values) and conductive, metallic layers (high U-values), heat can be better managed, thus reducing ultimate cold side temperature.

In the use of purely insulative materials (high R-value), hot-spotting and burn through is not uncommon as local flame temperatures can overmatch the ultimate melting point/burn through temperature of the insulative materials. By positioning a high melting point, high U-value material between the flame and the high R-value material, for example, the heat associated with the hot-spot may be diffused laterally through the high U-value material, and may reduce the transmitted temperature and eliminating the hot-spot seen by the high R-value material.

In the use of monolithic, conductive, high U-value materials (e.g., stainless steel), burn through may be unlikely, however, the surface temperature can get appreciably high. By putting a high R-value material on the back or front of the high U-value material, for example, thermal energy can be managed and the cold side temperature can be reduced. High U-value materials can also be used on the back of high R-value materials, as the former tend to be more durable than the high R-value materials, thus increasing durability of the overall assembly while further reducing system temperature via lateral heat spreading.

Ultimately, a flame barrier 100 may be engineered by intermixing high U-value, high R-value, and/or thermally active materials such that heat is managed via multiple, respective, synergistic mechanisms. High-R value materials selected from a group of insulative materials, provide a barrier to heat transfer, however these materials tend to be less robust/fragile with respect to secondary external stressors. High-U value materials, selected from a group of conductive/metallic materials, may provide durability along with the ability to move heat laterally, effectively reducing hot spots and temperature spikes, and ultimately reduce the temperature at the respective internal interface between the subject layer and subsequent materials.

As described previously, active materials, which may be used as adhesives or as part of a non-adhesive layer may include: (i) intumescent materials which may dynamically increase the airgap and reduce thermal conduction between layers, (ii) phase change materials which may absorb thermal energy as they transition between solid, liquid, and gaseous phases, (iii) hydrated, inorganic compounds which may be inherently incombustible and release water molecules as they absorb heat (and these water molecules absorb additional heat as their temperature raises and/or go through a phase change).

In all embodiments, the flame barrier 100 may be used with minimal change or redesign of a substrate 112. This advantageously eliminates the need for costly R&D and/or product recertification costs.

Through modification and optimization of the above-defined elements (e.g., a metallic layer 102, a non-metallic layer 104, an adhesive 106, etc.), the flame barrier 100 may be used in a wide variety of applications and in conjunction with a wide variety of substrates 112. The flame barrier 100 may be formable and may be adhered or mechanically fastened through multiple methods. The flame barrier 100 may be used in conjunction with sensitive containment materials. The substrate 112 may be an existing flame barrier to provide increased fire resistance and increased protective ability.

The following uses of the above-described flame barrier are contemplated, though the flame barrier is in no way limited to the enumerated uses.

### Shipping Container

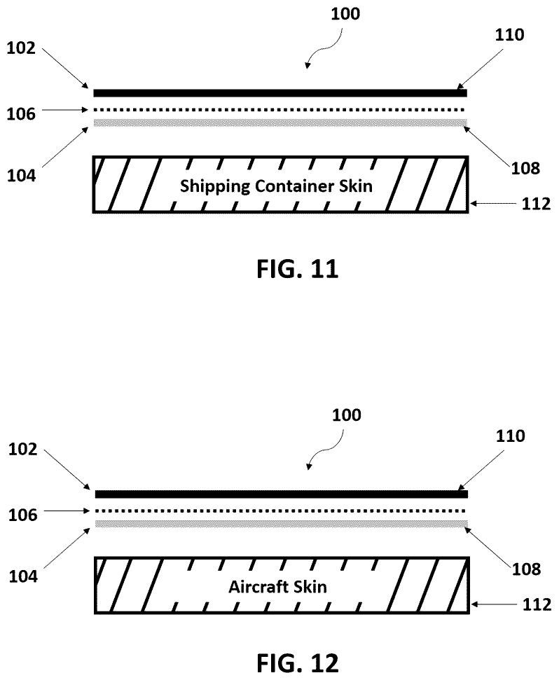

Referring to FIG. 11, a flame barrier 100 may be used in conjunction with a shipping container, such that the shipping container is the substrate 112. A shipping container may be defined as a container used for shipment, storage, and/or handling of various products, materials, etc. The shipping container may be any shape and be made of any material (e.g., steel, aluminum, fiber-reinforced polymer, etc.).

For example, the substrate 112 may be a shipping container wherein the cold face 108 of the flame barrier 100 may be configured to attach to the composite skin of the shipping container.

Additionally, the substrate 112 may be a shipping container flexible fabric roll-up door wherein the cold face 108 of the flame barrier 100 may be configured to attach to the flexible fabric door of the shipping container.

Attachment of the flame barrier 100 to the shipping container may be via adhesive (e.g., adhesive 106) or a mechanical fastening means (e.g., mechanical fastener 107).

### Aircraft

Referring to FIG. 12, a flame barrier 100 may be used in conjunction with an aircraft, such that the skin of the aircraft is the substrate 112. Exemplary aircraft include commercial aircraft (e.g., airplanes, helicopters, etc.), cargo aircraft, light-sport aircraft, military/fighter aircraft, etc.

The flame barrier 100 may be attached to various surfaces (e.g., “skins”) related to the aircraft. For example, the substrate 112 may be an aircraft wherein the cold face 108 of the flame barrier 100 may be configured to attach to the interior surface of the aircraft cargo-hold, replacing the traditional “cargo-liner’ while increasing the temperature resistant capabilities above the regulatory minimum temperature capability of 14 CFR 25.853 Part III, Boeing BSS 7323, Airbus AITM 2.0010, FAA Fire Test Handbook Chapter 8. Attachment of the flame barrier 100 to the cargo-hold may be via adhesive (e.g., adhesive 106) or a mechanical fastening means (e.g., mechanical fastener 107).

In another exemplary use, specifically, the flame barrier 100 may be used with the commercial aircraft fan-blade containment system, where temperatures are high enough that metallic containment and/or a combination of temperature insulation and traditional composite armor is employed. a flame barrier 100 may be used to lower the temperature that a composite armor panel would see to below that of the degradation temperature of a protective liner itself.

In another exemplary use, specifically, the flame barrier 100 may be used with a spacecraft or rocket, where temperatures are high enough on re-entry that a heat-shield is needed to protect the skin and structure of the aircraft. A flame barrier 100 may be used to lower the temperature that the craft itself would see to below that of the degradation temperature of the spacecraft itself.

### Battery Enclosures (Electric Vehicles)

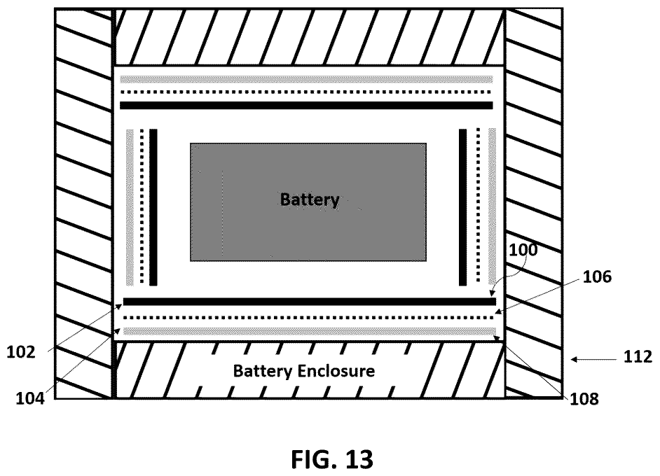

Referring to FIG. 13, a flame barrier 100 may be used in conjunction with battery enclosures, such as battery enclosures included in electric or hybrid cars, such that the battery enclosure is the substrate 112. For example, the flame barrier 100 may comprise or be part of the inner surface of a composite or metallic battery enclosure, wherein the cold face 108 of the flame barrier 100 may be proximal to the battery enclosure. Similarly, the flame barrier 100 may make up containment cells within a battery enclosure, or may even be a stand-alone structure to provide the safe transport, storage, and handling of bulk lithium ion batteries assembled for electric or hybrid vehicle use. Similarly, the flame barrier may be attached to a composite skid-plate or spall liner that protects the interior of the vehicle (e.g., battery) from abuse impacts and punctures which could cause thermal runaway of the batteries.

Attachment of the flame barrier 100 may be via adhesive (e.g., adhesive 106) or a mechanical fastening means (e.g., mechanical fastener 107).

### Battery Enclosures (Ballistic Gatling Gun)

A flame barrier 100 may be used in conjunction with battery enclosures for an electrically driven ballistic Gatling gun, such that the battery enclosure is the substrate 112 (see, e.g., FIG. 13). For example, the flame barrier 100 may comprise or be part of the inner surface of a composite or metallic battery enclosure, wherein the cold face 108 of the flame barrier 100 may be proximal to the battery enclosure. Similarly, the flame barrier may make up containment cells within a battery enclosure or may even be a stand-alone structure to provide the safe transport, storage, handling, and use of lithium-ion batteries assembled for electrically driven ballistic Gatling gun use. Attachment of the flame barrier 100 to the Gatling Gun battery enclosure be via adhesive (e.g., adhesive 106) or a mechanical fastening means (e.g., mechanical fastener 107).

Battery Enclosures (Electrical Vehicle Take-Off and Landing (eVTOL) Vehicles)

A flame barrier 100 may be used in conjunction with battery enclosures in eVTOL vehicles, such that the battery enclosure is the substrate 112 (see, e.g., FIG. 13). For example, the flame barrier 100 may comprise or be part of the inner surface of a composite or metallic battery enclosure, wherein the cold face 108 of the flame barrier 100 may be proximal to the battery enclosure. Similarly, the flame barrier may make up containment cells within a battery enclosure or may even be a stand-alone structure to provide the safe transport, storage, handling, and usage of lithium-ion batteries assembled for eVTOL use.

Attachment of the flame barrier 100 may be via adhesive (e.g., adhesive 106) or a mechanical fastening means (e.g., mechanical fastener 107).

Battery Enclosures (Electrically Controlled and/or Propelled Ballistic Missiles and Ordnance)

A flame barrier 100 may be used in conjunction with battery enclosures for electrically controlled and/or propelled ballistic missiles and ordnance, such that the battery enclosure is the substrate 112 (see, e.g., FIG. 13). For example, the flame barrier 100 may comprise or be part of the inner surface of a composite or metallic battery enclosure, wherein the cold face 108 of the flame barrier 100 may be proximal to the battery enclosure. Similarly, the flame barrier may make up containment cells within a battery enclosure or may even be a stand-alone structure to provide the safe transport, storage, handling, and use of lithium-ion batteries assembled for electrically controlled and/or propelled ballistic missiles and ordnance.

Attachment of the flame barrier 100 may be via adhesive (e.g., adhesive 106) or a mechanical fastening means (e.g., mechanical fastener 107).

### Computer Server/Data Rooms

A flame barrier 100 may be used in conjunction with computer server/data rooms including batteries used in backup systems. For example, the flame barrier 100 may comprise or be part of the inner surface of a composite or metallic battery enclosure, wherein the cold face 108 of the flame barrier 100 may be proximal to the battery enclosure. Similarly, the flame barrier may make up containment cells within a battery enclosure or may even be a stand-alone structure to provide the safe transport, storage, usage, and handling of lithium-ion batteries assembled for computer server/data rooms including batteries used in backup systems. Similarly, the flame barrier could be applied to common construction materials to provide a substrate that provides additional fire-rated barriers for garages or other storage rooms where battery charging and storage may occur.

### Electrically Driven Watercraft and Propulsion Systems

a flame barrier 100 may be used in conjunction with electrically driven watercraft and propulsion systems. For example, the flame barrier 100 may comprise or be part of the inner surface of a composite or metallic battery enclosure, wherein the cold face 108 of the flame barrier 100 may be proximal to the battery enclosure. Similarly, the flame barrier may make up containment cells within a battery enclosure or may even be a stand-alone structure to provide the safe transport, storage, usage, and handling of lithium-ion batteries assembled for electrically driven watercraft and propulsion systems.

### Auxiliary Power Unit (APU) Surround or APU Battery Enclosure

A flame barrier 100 may be used in conjunction with an aircraft. For example, the substrate 100 may be an aircraft auxiliary power unit (APU) surround or APU battery enclosure that may be lined with the flame barrier. The hot face 110 may be oriented inward, fire-hardening the interior surface of the APU surround or APU battery enclosure while increasing the temperature resistant capabilities above the regulatory minimum and protecting the surrounding traditional containment structure from temperature hot enough to cause structural degradation.

### EXAMPLES

### Example 1

In this example, seven flame barrier samples were prepared and tested.

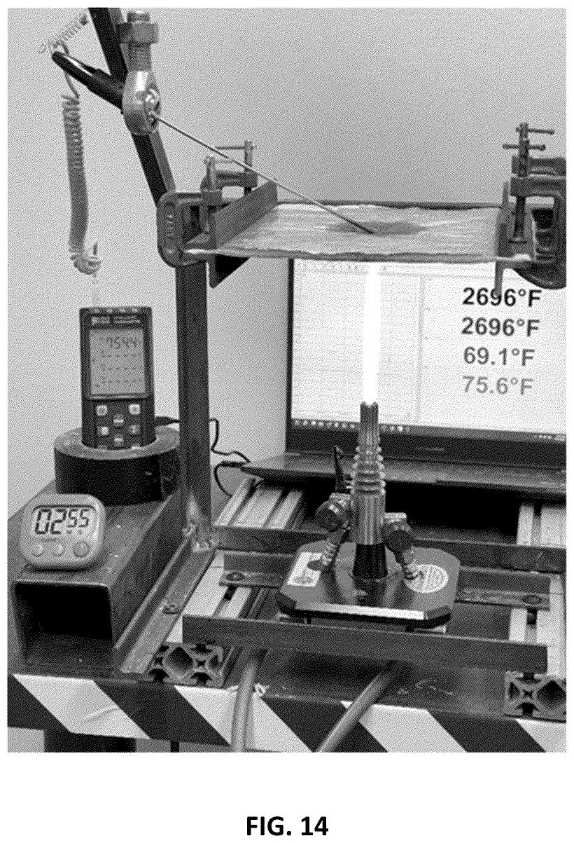

Samples were affixed in place using clamp loading on the sides of the samples (FIG. 14). A thermocouple were placed on the cold face of the sample, in line with a torch head. The cold face of the sample was also measured with a pyrometer. A high temperature thermocouple was placed 2.5″ from the tip of the torch and was utilized to calibrate the flame temperature prior to testing. The torch used a mixture of oxygen and propane to reach the desired temperature. A flow of propane was started to ignite the torch. Once ignited a high flow of oxygen (>30 LPM) was added, and propane was adjusted until the desired temperature was reached and stabilized.

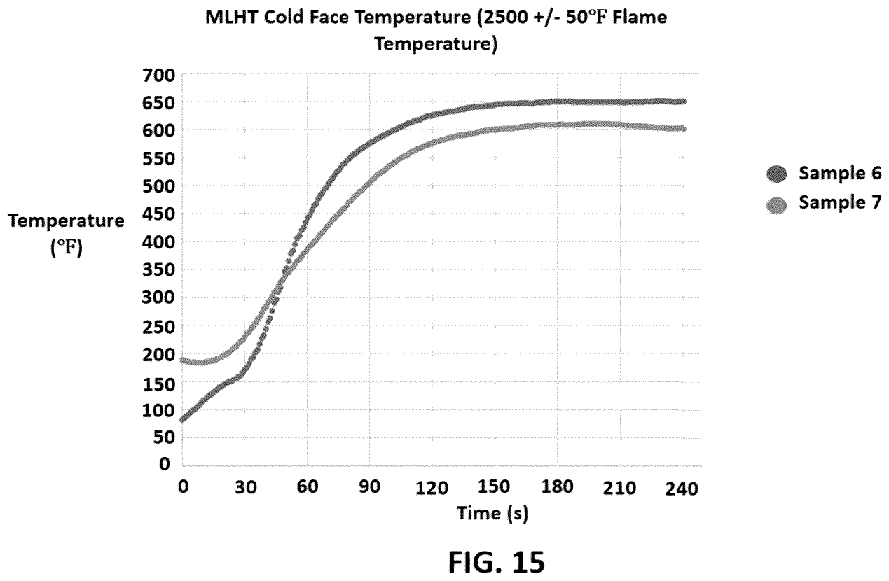

While all test sample, torch, and thermocouple locations were standardized on fixturing, a tolerance band is included in the test graphs (see FIG. 15) based on the extreme ranges of temperatures readable in different areas of the flame. Moreover, minor environmental changes (e.g., walking out of the room, or the building HVAC cycling on) caused slight air-flow changes in the room that were sufficient to make the flame move around the fixed thermocouple, changing continual temperature data collection with fluctuations in the data.

Once the desired temperature was reached, the torch was brought close to the surface of the sample and held in place for the duration of the test. The cold face temperature data was collected from the thermocouple and their values were averaged and plotted (see FIG. 15).

Sample 1 (comparative example) consisted of a stainless-steel foil layer as the flame barrier's hot face and an aramid reinforced thermoset laminate layer as the flame barrier's cold face, wherein the layers were attached with adhesive. Sample 2 (comparative example) consisted of vermiculite coated fiberglass layer (0.080 inches thick). Sample 3 (comparative example) consisted of a silica fabric layer. Sample 4 (comparative example) consisted of a non-woven silica layer. Sample 5 (comparative example) consisted of an aramid reinforced thermoset laminate layer as the flame barrier's hot face, a stainless-steel foil layer, and a non-woven silica layer as the flame barrier's cold face, wherein the layers were attached with Super 77 Bond adhesive.

In this flame test, the barriers were exposed to a 2,500° F.-point load flame for a duration of 270 seconds, and the cold side temperatures were recorded. These test results are displayed in Table 1. An inherent tolerance/error (e.g., +/−50° F.) should be accounted for.

TABLE 1
Testing Results of Samples 1-5

| | | | | | |
|---|---|---|---|---|---|
| | Pyrometer | Thermocouple | | | |
| Test | Average | Post Test | Pyrometer | Time | Pass (P)/ |
| # | (° F.) | (° F.) | Attenuation | (s) | Fail (F) |

SAMPLE 1

| | | | | | |
|---|---|---|---|---|---|
| 1 | 2,698 | 2,560 | 5.40% | 172 | F |
| 2 | 2,638 | 2,540 | 3.88% | 240 | F |

SAMPLE 2

| | | | | | |
|---|---|---|---|---|---|
| 1 | 2,040 | 2,437 | 16.26% | 58.6 | F |
| 2 | 2,397 | 2,532 | 5.30% | 31 | F |
| 3 | 2,469 | 2,472 | 0.11% | 47 | F |

SAMPLE 3

| | | | | | |
|---|---|---|---|---|---|
| 1 | 2,372 | 2,571 | 7.72% | 270 | F |

SAMPLE 4

| | | | | | |
|---|---|---|---|---|---|
| 1 | 2,400 | 2,552 | 5.96% | 270 | F |

SAMPLE 5

| | | | | | |
|---|---|---|---|---|---|
| 1 | 2,500 | 2,500 | 0.00% | 270 | F |

Each of Samples 1-5 displayed failing results, as the samples were unable to maintain cold side temperatures below a target temperature (e.g., 600° F.). Sample 1 failed due to the introduction of a particular woven aramid as a fuel source throughout the test, causing flames to erupt from the boundaries of the sample. Samples 2-4 allowed flame penetration and therefore failed. Sample 5 failed due to the adhesive, which generated fuel and added energy to the flame reaction causing burn-through and/or other failing criteria. These samples failed to withstand the high temperatures indicative of lithium-ion battery failure.

Samples 6 and 7 were inventive examples of the flame barrier described above. Sample 6 consisted of an aramid reinforced thermoset laminate layer, a stainless-steel foil layer, a carbon layer, and a non-woven silica layer as consecutive layers. Sample 7 consisted of an aramid reinforced thermoset laminate layer, a carbon layer, a stainless-steel foil layer, and a non-woven silica layer as consecutive layers.

Samples 6 and 7 were tested with a 2,500° F.-point load flame exposure for a duration of 240 seconds using the measurement collection and testing specifications previously mentioned. These test results are displayed in FIG. 15.

Each of Samples 6 and 7 displayed passing results. Samples 6 and 7 were capable of a 15-minute exposure to a 2,500° F. flame while maintaining cold side temperatures at or below a target temperature (e.g., 600° F.). It is noted that the graph shown in FIG. 15 notes the inherent tolerance/error associated with these tests. Accordingly, while Samples 6 and 7 appear to exceed 600° F., when accounting for the tolerance/error, the samples are still considered to be “passing samples.”

It is also noted that the differences in starting temperatures between Samples 10 and 11 shown in FIG. 15 were a function of when the data collection was turned on (after flame application). The data shown in FIG. 15 was “live” data captured when the test operator started data collection, not when the flames were turned on/applied to the strike face.

While individual materials displayed failing results (see Table 1), when combined correctly (e.g., Samples 6 and 7), materials displayed their most advantageous traits alongside one another to create a high-temperature resistant flame barrier while retaining desired mechanical properties.

### Example 2

In this example, nine flame barrier samples were prepared and tested as parts of experiments studying the effects of numerous variables.

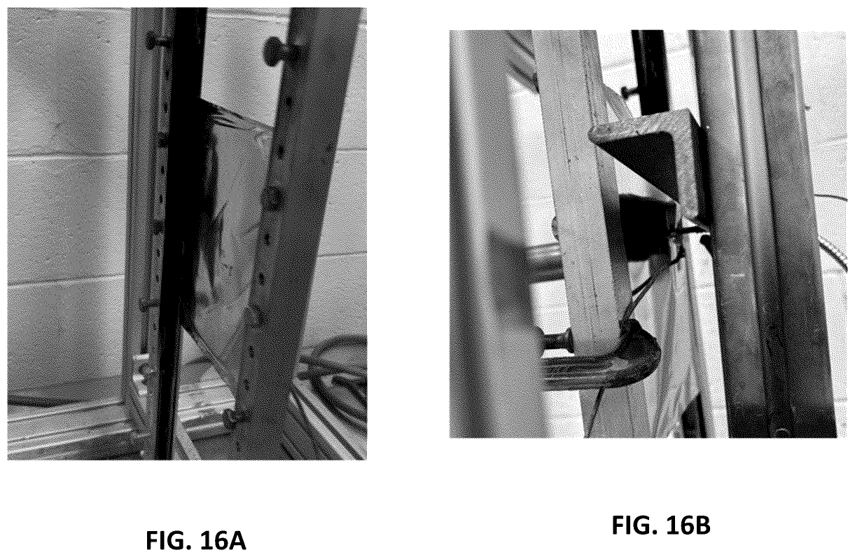

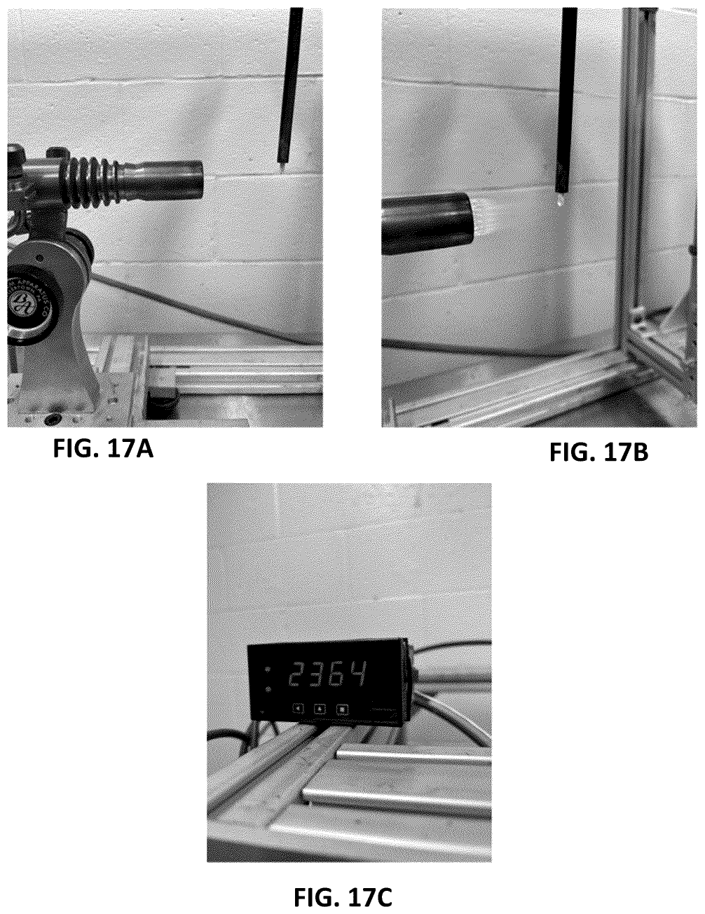

In this example, 8-inch by 8-inch samples were affixed in place using clamp loading on the sides of the samples (FIG. 16A). Two K-type thermocouples were placed on the cold face of the sample, in line with a torch head (FIG. 16B). A B-type (high temperature) thermocouple was placed 2.5″ from the tip of the torch and was utilized to calibrate the flame temperature (FIGS. 17A and 17B). The torch used a mixture of oxygen and propane to reach the desired temperature. A flow of propane was started to ignite the torch. Once ignited a high flow of oxygen (>30 LPM) was added, and propane was adjusted until the desired temperature was reached and stabilized (see FIG. 17C).

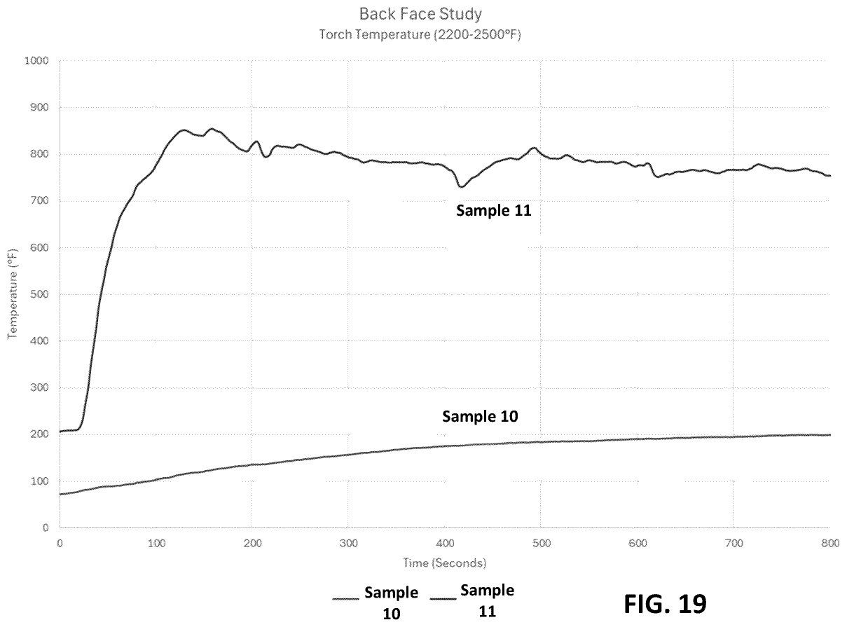

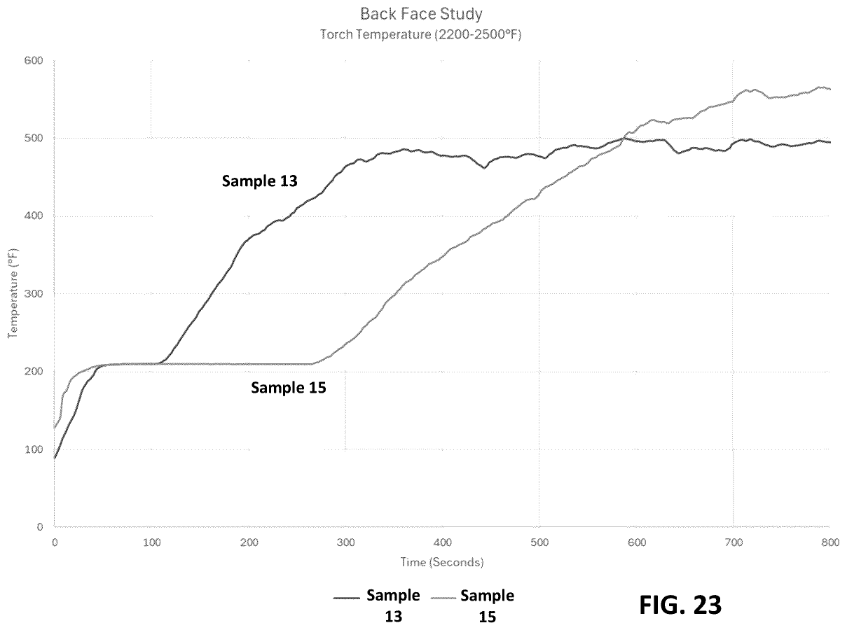

While all test sample, torch, and thermocouple locations were standardized on fixturing, temperature tolerance bands are included on all test graphs (see FIGS. 19-28) based on the extreme ranges of temperatures readable in different areas of the flame. Moreover, minor environmental changes (e.g., walking out of the room, or the building HVAC cycling on) caused slight air-flow changes in the room that were sufficient to make the flame move around the fixed thermocouple, changing continual temperature data collection with fluctuations in the data.

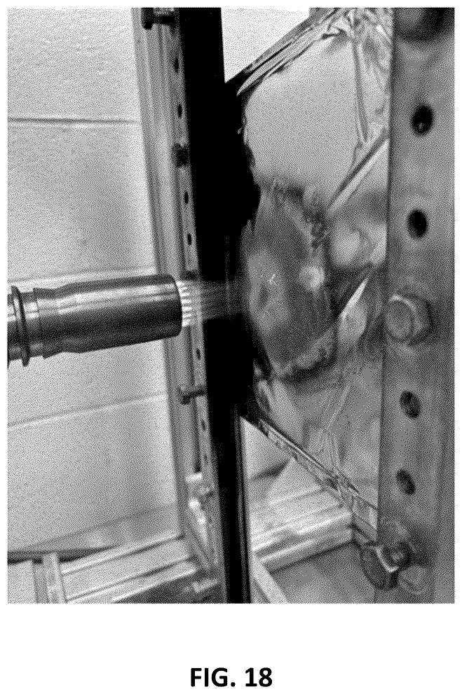

Once the desired temperature was reached, the torch was brought 2.5″ from the surface of the sample and held in place for the duration of the test (see FIG. 18). Tests were typically conducted for 12-15 minutes or longer. The cold face temperature data was collected from both of the K-type thermocouples and their values are averaged and plotted (see FIGS. 19-29).

In a single pack vs. multi-pack study (for purposes of the examples, a pack was defined as two metallic layers with a non-metallic layer positioned therebetween), a multi-pack sample barrier (Sample 10) consisted of the following consecutive layers (listed in order from hot face to cold face): 2 mil stainless steel foil, 0.125″ ceramic paper, 2 mil stainless steel foil, 0.125″ ceramic paper, 2 mil stainless steel foil, 0.125″ ceramic paper, 2 mil stainless steel foil, 0.125″ ceramic paper, 2 mil stainless steel foil, 0.125″ ceramic paper, 2 mil stainless steel foil, 0.125″ ceramic paper, and 2 mil stainless steel foil. The layers were attached with an adhesive (sodium silicate).

A single pack sample barrier (Sample 11) consisted of the following consecutive layers (listed in order from hot face to cold face): 2 mil stainless steel foil, 0.125″ ceramic paper, and 2 mil stainless steel foil. The layers were attached with an adhesive (sodium silicate).

Samples 10 and 11 were tested with a 2,400° F.-point load flame exposure using the measurement collection and testing specifications previously mentioned. These test results are displayed in FIG. 19. An inherent tolerance/error (e.g., +/−50° F.) should be accounted for.

### Example 3

The testing methodology described above with respect to Example 2 was also used for this example.

A sample barrier (Sample 12) consisted of the following consecutive layers (listed in order from hot face to cold face): 2 mil stainless steel foil, 0.0625″ ceramic paper, and 2 mil aluminum foil. The layers were attached with an adhesive (sodium silicate).

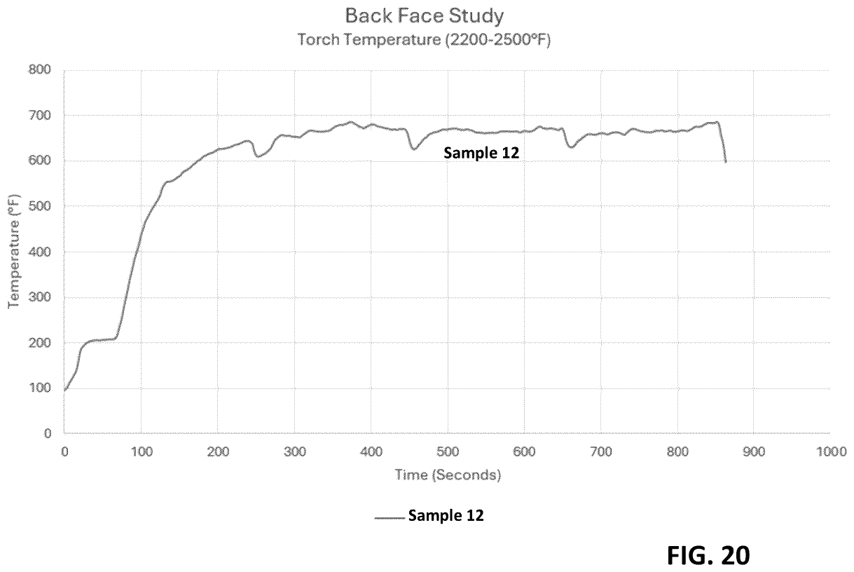

Sample 12 was tested with a 2,400° F.-point load flame exposure using the measurement collection and testing specifications previously mentioned. These test results are displayed in FIG. 20. An inherent tolerance/error (e.g., +/−50° F.) should be accounted for.

### Example 4

The testing methodology described above with respect to Example 2 was also used for this example.

In a layered vs. single pack study, a layered sample barrier (Sample 13) consisted of the following consecutive layers (listed in order from hot face to cold face): 2 mil stainless steel foil, 0.0625″ ceramic paper, 1 mil aluminum foil, 0.0625″ ceramic paper, and 1 mil aluminum foil. The layers were attached with an adhesive (sodium silicate).

The single pack sample barrier (Sample 11) was described above in Example 2.

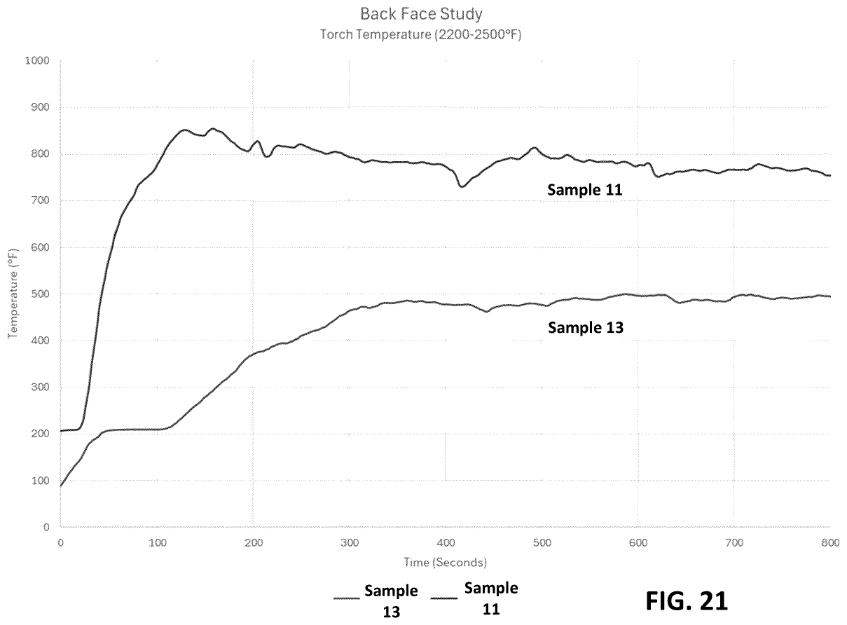

Samples 13 and 11 were tested with a 2,400° F.-point load flame exposure using the measurement collection and testing specifications previously mentioned. These test results are displayed in FIG. 21. An inherent tolerance/error (e.g., +/−50° F.) should be accounted for.

### Example 5

The testing methodology described above with respect to Example 2 was also used for this example.

In a symmetrical vs. unsymmetrical study, a symmetrical sample barrier (Sample 13) was described above in Example 4.

An unsymmetrical sample barrier (Sample 14) consisted of the following consecutive layers (listed in order from hot face to cold face): 2 mil stainless steel foil, 0.0625″ ceramic paper, 1 mil aluminum foil, 0.0625″ ceramic paper, and 1 mil stainless steel foil. The layers were attached with an adhesive (sodium silicate).

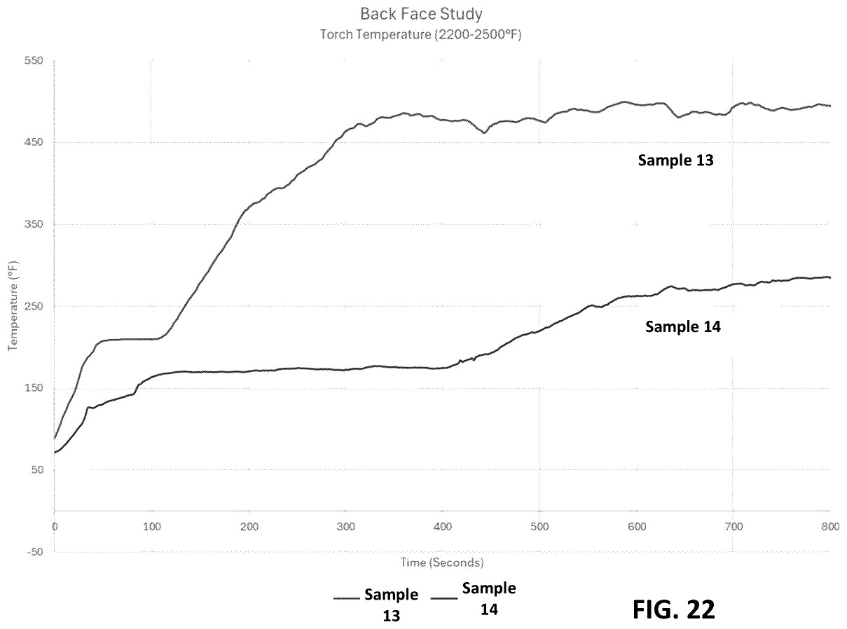

Samples 13 and 14 were tested with a 2,400° F.-point load flame exposure using the measurement collection and testing specifications previously mentioned. These test results are displayed in FIG. 22. An inherent tolerance/error (e.g., +/−50° F.) should be accounted for.

### Example 6

The testing methodology described above with respect to Example 2 was also used for this example.

In a 1 mil hot face vs. 2 mil hot face study, a 2 mil hot face sample barrier (Sample 13) was described above in Example 4.

A 1 mil hot face sample barrier (Sample 15) consisted of the following consecutive layers (listed in order from hot face to cold face): 1 mil stainless steel foil, 0.0625″ ceramic paper, 1 mil aluminum foil, 0.0625″ ceramic paper, and 2 mil aluminum foil. The layers were attached with an adhesive (sodium silicate).

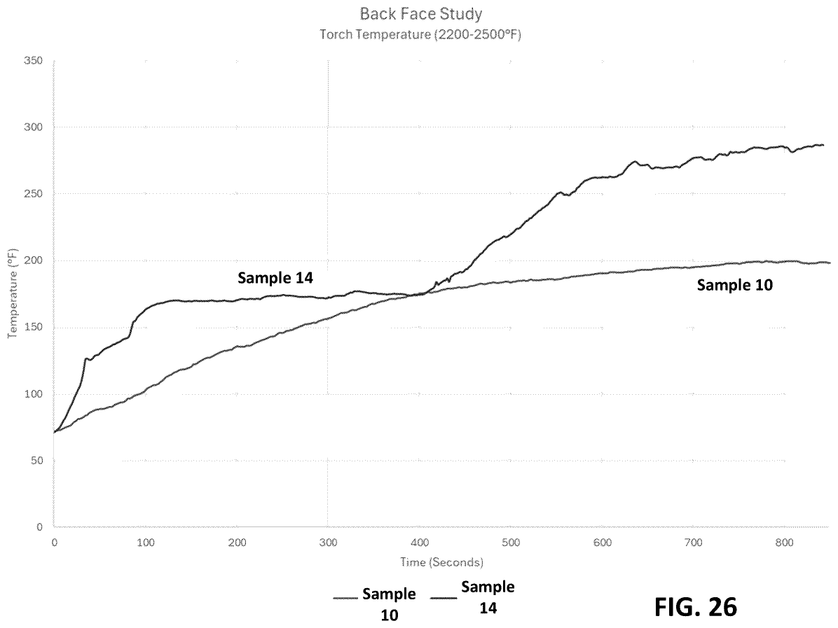

Samples 13 and 15 were tested with a 2,400° F.-point load flame exposure using the measurement collection and testing specifications previously mentioned. These test results are displayed in FIG. 26. An inherent tolerance/error (e.g., +/−50° F.) should be accounted for.

### Example 7

The testing methodology described above with respect to Example 2 was also used for this example.

In a 1 mil cold face vs. 2 mil cold face study, a 1 mil cold face sample barrier (Sample 14) was described above in Example 5.

A 2 mil cold face sample barrier (Sample 16) consisted of the following consecutive layers (listed in order from hot face to cold face): 2 mil stainless steel foil, 0.0625″ ceramic paper, 1 mil aluminum foil, 0.0625″ ceramic paper, and 2 mil stainless steel foil. The layers were attached with an adhesive (sodium silicate).

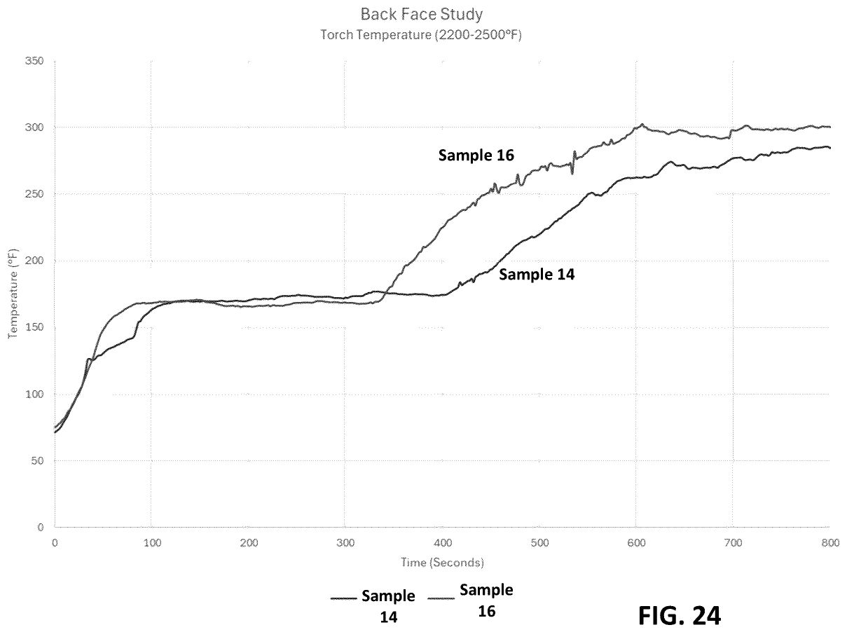

Samples 14 and 16 were tested with a 2,400° F.-point load flame exposure using the measurement collection and testing specifications previously mentioned. These test results are displayed in FIG. 24. An inherent tolerance/error (e.g., +/−50° F.) should be accounted for.

### Example 8

The testing methodology described above with respect to Example 2 was also used for this example.

In an insulated vs. non-insulated study, an insulated sample barrier (Sample 13) was described above in Example 4.

A non-insulated sample barrier (Sample 17) consisted of the following consecutive layers (listed in order from hot face to cold face): 2 mil stainless steel foil, 1 mil aluminum foil, and 1 mil aluminum foil. The layers were attached with an adhesive (sodium silicate).

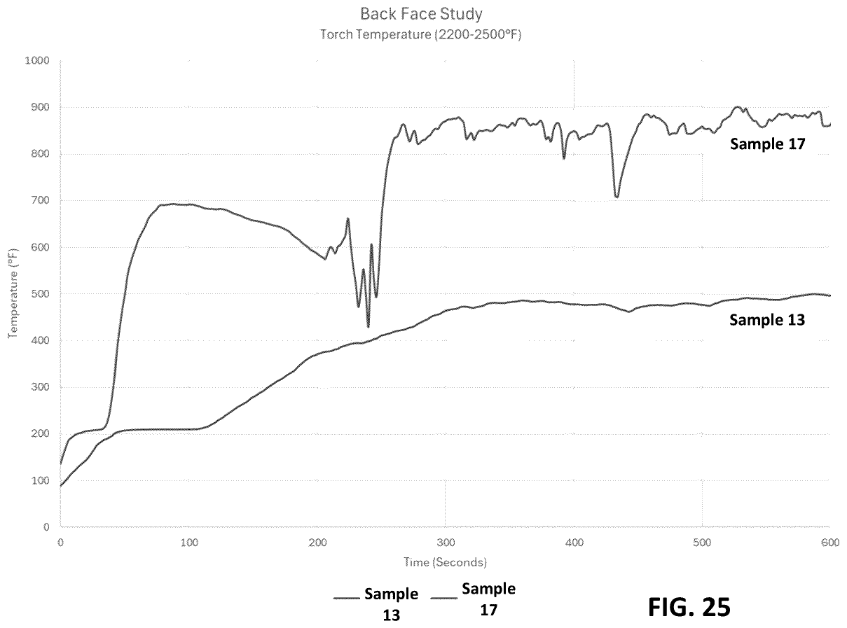

Samples 13 and 17 were tested with a 2,400° F.-point load flame exposure using the measurement collection and testing specifications previously mentioned. These test results are displayed in FIG. 25. An inherent tolerance/error (e.g., +/−50° F.) should be accounted for.

### Example 9

The testing methodology described above with respect to Example 2 was also used for this example.

In this study, a first sample barrier (Sample 10) was described above in Example 2. A second sample barrier (Sample 14) was described above in Example 5.

Samples 10 and 14 were tested with a 2,400° F.-point load flame exposure using the measurement collection and testing specifications previously mentioned. These test results are displayed in FIG. 26. An inherent tolerance/error (e.g., +/−50° F.) should be accounted for.

### Example 10

The testing methodology described above with respect to Example 2 was also used for this example.

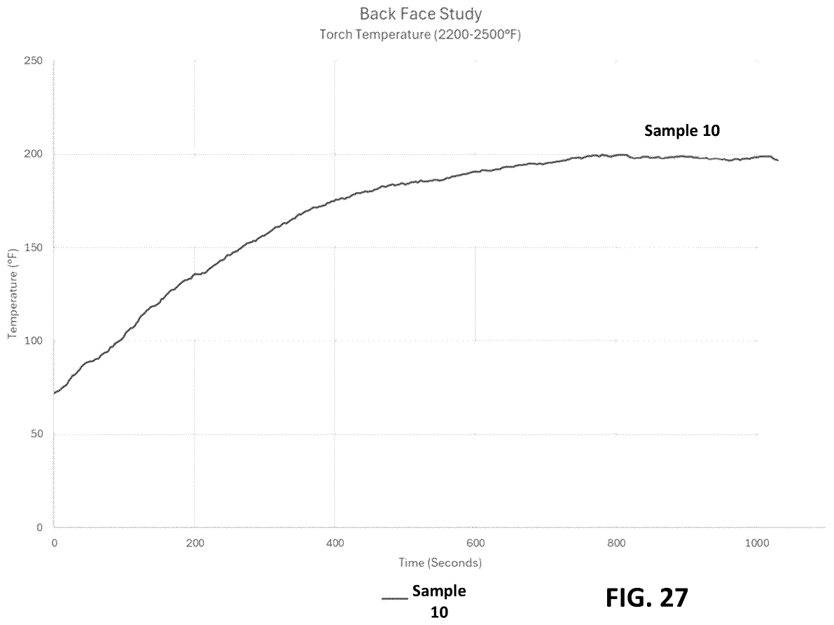

In steady state study, a sample barrier (Sample 10) was described above in Example 2. Sample 10 was tested with a 2,400° F.-point load flame exposure using the measurement collection and testing specifications previously mentioned. These test results are displayed in FIG. 27. An inherent tolerance/error (e.g., +/−50° F.) should be accounted for.

### Example 11

The testing methodology described above with respect to Example 2 was also used for this example.

In traditional FR laminate vs. inventive example study, a first traditional sample barrier (Sample 18) consisted of the following consecutive layers (listed in order from hot face to cold face): 2 mil stainless steel foil, Industry Std FR-Laminate, and 2 mil aluminum foil. The layers were attached with an adhesive (sodium silicate). A second sample barrier (Sample 14) was described above in Example 5.

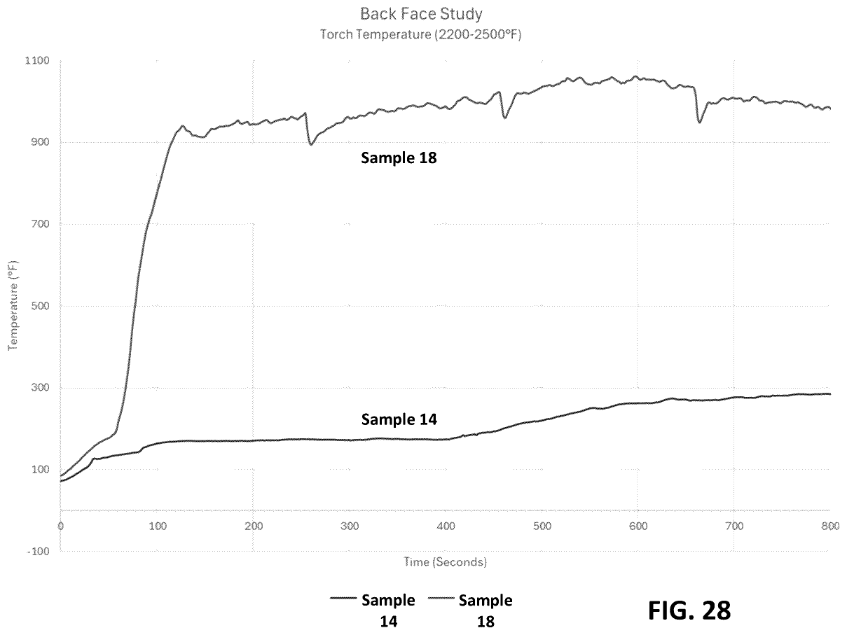

Samples 18 and 14 were tested with a 2,400° F.-point load flame exposure using the measurement collection and testing specifications previously mentioned. These test results are displayed in FIG. 28. An inherent tolerance/error (e.g., +/−50° F.) should be accounted for.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A flame barrier, comprising:
a first metallic layer having a thickness of from 0.08 mils or greater to 20 mils or less;
a second metallic layer having a thickness of from 0.08 mils or greater to 20 mils or less; and
a non-metallic layer positioned between the first metallic layer and the second metallic layer,
wherein the flame barrier is configured to maintain a cold side temperature of 700° F. or less in an environment with temperatures up to 2,400° F.

2. The flame barrier of claim 1, wherein the first metallic layer has a thickness of from 0.8 mils or greater to 2 mils or less, and wherein the second metallic layer has a thickness of from 0.8 mils or greater to 2 mils or less.

3. The flame barrier of claim 1, wherein the first metallic layer is a first metal foil layer comprising a first metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

4. The flame barrier of claim 3, wherein the second metallic layer is a second metal foil layer comprising a second metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

5. The flame barrier of claim 4, wherein the first metal is the same as the second metal.

6. The flame barrier of claim 4, wherein the first metal is different than the second metal.

7. The flame barrier of claim 1, wherein the non-metallic layer comprises a material selected from the group consisting of woven silica fabric, woven vermiculite coated fiberglass, non-woven silica fiber, woven aramids, mica, ceramic, basalt, para-aramid, meta-aramid, carbon, graphite, glass fiber, and mixtures thereof.

8. The flame barrier of claim 7, wherein the non-metallic layer comprises ceramic.

9. The flame barrier of claim 1, wherein the non-metallic layer is attached to the first metallic layer and the second metallic layer via an adhesive.

10. The flame barrier of claim 9, wherein the adhesive comprises at least one inorganic salt and an aqueous binder solution.

11. The flame barrier of claim 10, wherein the at least one inorganic salt is sodium silicate.

12. The flame barrier of claim 1, further comprising:
an air gap positioned between the first metallic layer and the non-metallic layer and/or between the second metallic layer and the non-metallic layer.

13. The flame barrier of claim 1, further comprising:
a third metallic layer having a thickness of from 0.08 mils or greater to 20 mils or less;
a second non-metallic layer positioned between the second metallic layer and the third metallic layer,
wherein the flame barrier is configured to maintain a cold side temperature of 400° F. or less in an environment with temperatures up to 2,400° F.

14. The flame barrier of claim 13, wherein the third metallic layer has a thickness of from 0.8 mils or greater to 2 mils or less.

15. The flame barrier of claim 13, wherein the third metallic layer is a third metal foil layer comprising a third metal selected from the group consisting of alloy steels, aluminum (and alloys), brass, bronze, carbon steel, cobalt (and alloys), Constantan® foil (Cu55Ni), copper (and alloys), Evanohm® foil (Ni75Cr20Al2.5Cu2.5), gold (and alloys), iron (and allows), magnesium (and alloys), nickel (and alloys), nickel-base super alloys (e.g., Inconel®), niobium (and alloys), stainless steel (e.g., stainless steel type 309, stainless steel type 321), tantalum (and alloys), tin (and alloys), titanium (and alloys), tungsten (and alloys), yttrium (and alloys), zinc (and alloys), and mixtures thereof.

16. The flame barrier of claim 13, wherein the second non-metallic layer comprises a material selected from the group consisting of woven silica fabric, woven vermiculite coated fiberglass, non-woven silica fiber, woven aramids, mica, ceramic, basalt, para-aramid, meta-aramid, carbon, graphite, glass fiber, and mixtures thereof.

17. The flame barrier of claim 16, wherein the second non-metallic layer comprises ceramic.

18. The flame barrier of claim 13, wherein the non-metallic layer is attached to the first metallic layer and the second metallic layer via an adhesive, and wherein the second non-metallic layer is attached to the second metallic layer and the third metallic layer via the adhesive.

19. The flame barrier of claim 18, wherein the adhesive comprises sodium silicate.

20. The flame barrier of claim 13, further comprising:
an air gap positioned between the first metallic layer and the non-metallic layer and/or between the second metallic layer and the non-metallic layer and/or between the second metallic layer and the second non-metallic layer and/or between the third metallic layer and the second non-metallic layer.
